(19) United States
(12) Patent Application Publication
(10) Pub. No.: US 2003/0137831 A1
(43) Pub. Date: Jul. 24, 2003

(54) Tile in combination with a solar lamp

(76) Inventor: Chung-Kuei Lin, Hsinchuang City (TW)

Correspondence Address: Cooper & Dunham LLP, 1185 Avenue of the Americas, New York, NY, 10036, US

(21) Appl. No.: 10/052,083

(22) Filed: Jan. 18, 2002

(51) Int. Cl. F21L 13/00; E01F 9/00

(52) U.S. Cl. 362/183; 362/153.1

(57) ABSTRACT

A tile in combination with a solar lamp such that the solar lamp is securely mounted at the center of the tile. The solar lamp has a base and a chamber is defined in the base. A hollow boss is located in the chamber and batteries are received in the hollow boss. A solar cell panel is firmly attached on top of the hollow boss to convert solar energy into electricity to charge the batteries. Light bulbs and a circuit board are mounted in the chamber and adjacent to the boss. The solar cell panel, the light bulbs and the batteries are respectively and electrically connected to the circuit board. The light bulbs are controlled by the circuit board and supplied electricity by the batteries to light up automatically under a dim condition.

### BACKGROUND OF THE INVENTIONS

1. Field of the Invention

The present invention relates to a tile, and more particularly to a novel tile in combination with a solar lamp.

2. Description of Related Art

Tiles are articles to be placed typically on a sidewalk or a garden to create a pathway for walking which will remain suitable when the ground is wet through rain and so on. Instead of the purely functional purpose of creating the pathway, the tiles can also provide an ornamental effect. Therefore, most of the tiles currently available emphasize on the durability to enhance the functional purpose, or have attractive colors, patterns, and shapes to provide well ornamental effect.

However, under dark conditions such as at night, the tiles placed without nearby illumination cannot be seen and people may have trouble finding the pathway, not to mention the loss of the ornamental effect. In order to overcome this problem, illumination devices are disposed next to the tiles. Nevertheless, a further disadvantage in accompaniment with this solution is that additional cost is required not only to dispose the illumination devices but also to provide electricity to maintain the operation of such devices.

Therefore, the present invention intends to provide a tile in combination with a solar lamp to overcome the above problems.

### SUMMARY OF THE INVENTION

The objective of the present invention is to provide a tile in combination with a solar lamp whereby under dark conditions, the solar lamp illuminates automatically so that the tile can be easily seen and also provides an attractive effect. Moreover, the solar lamp makes use of the inexhaustible solar energy and therefore an external power supply is not required.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a tile in combination with a solar lamp in accordance with the present invention;

FIG. 2 is a perspective view of the solar lamp in assembly;

FIG. 3 is an exploded, perspective view of the solar lamp;

FIG. 4 is a cross-sectional, plane view of the solar lamp taken along line 4-4 of FIG. 3; and

FIG. 5 is another cross-sectional, plane view of the solar lamp taken along line 5-5 of FIG. 3.

### DETAILED DESCRIPTION OF THE PREFERRED EMBODIMENT

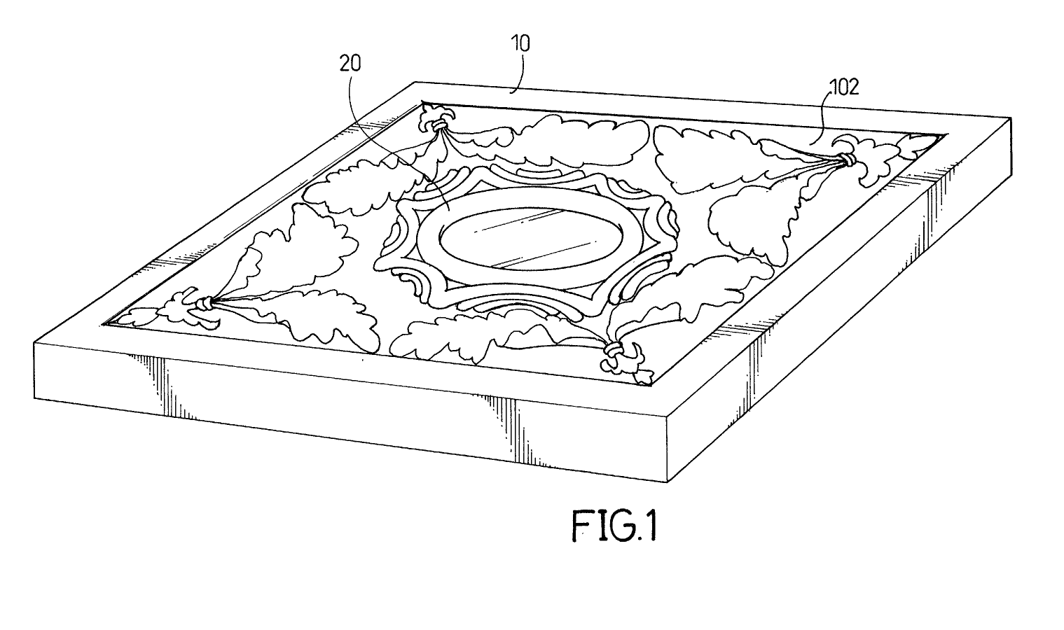

With reference to FIG. 1, a tile (10) in combination with a solar lamp (20) in accordance with the present invention is shown, wherein the solar lamp (20) is securely mounted in the center of the tile (10).

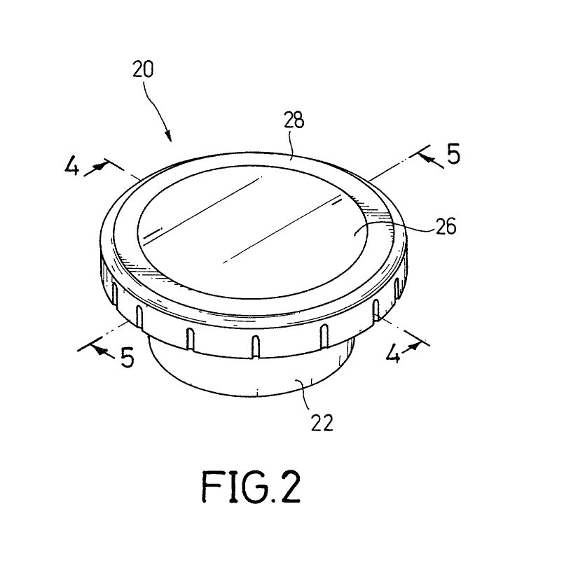

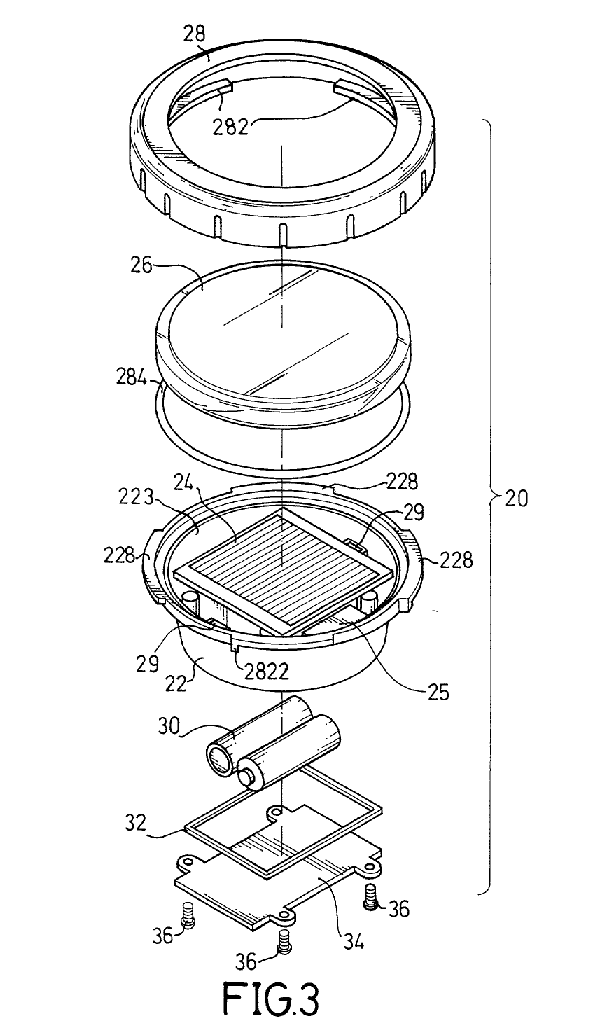

With reference to FIGS. 2 and 3, the solar lamp (20) includes a hollow base (22), a solar cell panel (24), a circuit board (25), a glass (26), a retaining ring (28), light bulbs (29) and batteries (30).

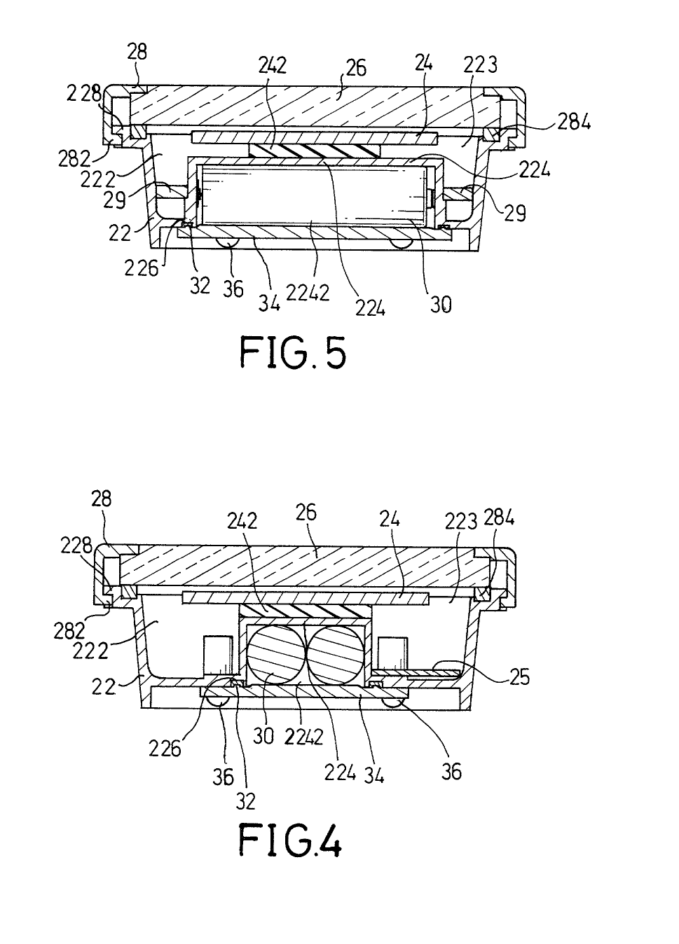

With reference to FIGS. 4 and 5, the base (22) has a chamber (222) defined therein. A top opening (223) is defined in a top side of the base (22) and communicating with the chamber (222). A hollow boss (224) is formed on a bottom surface defining the chamber (222). A bottom opening (2242) is defined in a bottom side of the boss (224) so that the batteries (30) can be placed into an interior of the boss (224) via the bottom opening (2242). The solar cell panel (24) which is able to convert solar energy into electricity is securely mounted on top of the boss (224) by a layer of glue (242). The light bulbs (29) are securely mounted on the bottom surface defining the chamber (222) and adjacent to the boss (224). The circuit board (25) is also securely mounted on the bottom surface and located at a side of the boss (224). The solar cell panel (24) is electrically connected to the circuit board (25), and the circuit board (25) is further electrically and respectively connected to the light bulbs (29) and the batteries (30). As shown in FIG. 3, a sealing frame (32) preferably made of rubber is received in a groove (226) defined around the bottom opening (2242). A cap (34) then covers the bottom opening (2242) and the groove (226), and is threadingly connected to the base (22) by screws (36) while the sealing frame (32) prevents water from entering the interior of the boss (224). Outward flanges (228) extend from a top edge of the base (22) surrounding the top opening (223).

The retaining ring (28) is firmly glued around the glass (26). Inward flanges (282) extending from a bottom edge of the retaining ring (28) to mate the outward flanges (228). Each one of the inward flanges (282) has a stop (2822) extending downwardly therefrom as shown in FIG. 3. A sealing ring (284) preferably made of rubber is disposed on the top edge of the base (22). The retaining ring (28) together with the glass (26) is securely connected to the base (22) by sliding the outward flanges (228) respectively onto the inward flanges (282) until the outward flanges (228) abutting the stops (2822), while the sealing ring (284) prevents water from entering the chamber (222).

In operation, the tile (10) in combination with the solar lamp (20) is disposed onto the ground of, for example, a garden or a sidewalk. During daytime, when light is sufficient, the solar cell panel (24) converts solar energy into electricity. At the same time, the circuit board (25) senses this condition and shuts the light bulbs (29) off, and all of the electricity produced is used to charge the batteries (30). Under a dark condition, the solar cell panel (24) no longer generates electricity and the circuit board (25) senses this change and automatically turns the light bulbs (29) on. The electricity required for the light bulbs (29) to illuminate is provided by the batteries (30) which should normally be fully charged during the daytime.

Referring to FIGS. 1 and 2, the tile (10) has a top surface (102) formed with a pattern. The solar lamp (20) is securely mounted in the tile (10) while the glass (26) is flush with the top surface (102). Therefore, light generated by the light bulbs (29) can scatter out of the solar lamp (20) though the glass (26).

From the above description, a plurality of the tiles (10) in accordance with the present invention can be placed on the ground of, for example, a garden or a sidewalk to create a pathway which is attractive and safe during any natural lighting condition. People can walk on the top surface (102) of the tile (10) and the pattern thereon provides an ornamental effect as well as a slip-resistant effect. During daytime, the solar cell panel (24) charges the batteries (30) in the solar lamp (20). At night or under a dim condition, the light bulbs (29) illuminate automatically using the electricity provided by the batteries (30). Therefore, an automatically illuminated pathway is formed so as to to guide the people walking on the tiles (10). In addition, the lighting effect is unique and attractive such that the ornamental effect is enhanced. Moreover, the solar lamp (20) makes use of the inexhaustible solar energy so that an external power supply is not required, and thus certain costs are eliminated. Also the switching on-off of the solar lamp (20) is automatically controlled so that manual controlling is not required, and thus significant convenience is provided.

While this invention has been particularly shown and described with references to the preferred embodiment thereof, it will be understood by those skilled in the art that various changes in form and details may be made therein without departing from the scope of the invention encompassed by the appended claims.

What is claimed is:

1. In a tile having a solar lamp securely mounted therein, wherein the solar lamp comprises:
a base having a chamber defined in the base and a top opening communicating with the chamber, a hollow boss formed on a bottom surface of the base and located in the chamber;
a solar cell panel securely mounted on top of the hollow boss;
at least one light bulb securely mounted in the chamber and adjacent to the hollow boss;
at least one battery received in the hollow boss;
a circuit board securely mounted in the chamber at a side of the hollow boss, wherein the solar cell panel, the at least one battery and the at least one light bulb are respectively and electrically connected to the circuit board; and
a transparent panel securely mounted on the base to cover the top opening,
whereby, the solar cell panel is able to convert solar energy to electricity to charge the at least one battery, when under a dim condition, the circuit board automatically controls the at least one battery to supply an electric current to light up the at least one light bulb.

2. The tile as claimed in claim 1 further comprising a retaining ring securely mounted on the base and around the transparent panel to secure transparent panel in place.

3. The tile as claimed in claim 1, wherein the bottom surface of the base further has a bottom opening defined therein and communicated with an interior of the hollow boss so that the at least one battery is able to be placed into the interior via the bottom opening, and a cap is detachably mounted on the bottom surface and covers the bottom opening.

4. The tile as claimed in claim 1, wherein the transparent panel is a piece of glass.

5. The tile as claimed in claim 3, wherein the cap is detachably mounted on the bottom surface of the base by screws.

6. The tile as claimed in claim 3, wherein a sealing frame is sandwiched between the cover and the bottom surface and surrounds the bottom opening to prevent water from entering the interior of the hollow boss.

7. The tile as claimed in claim 2 further comprising a sealing ring sandwiched between the base and the retaining ring and surrounds the top opening of the base to prevent water from entering the chamber.
